(19) United States
(12) Patent Application Publication
(10) Pub. No.: US 2026/0051988 A1
(43) Pub. Date: Feb. 19, 2026

(54) METHOD FOR INTER-UE COORDINATION BASED ON SIDELINK, DEVICE AND STORAGE MEDIUM

(71) Applicant: Beijing Xiaomi Mobile Software Co., Ltd., Beijing (CN)

(72) Inventor: Xiaowei JIANG, Beijing (CN)

(21) Appl. No.: 19/101,871

(22) PCT Filed: Aug. 9, 2022
(86) PCT No.: PCT/CN2022/111261

§ 371 Date: Feb. 6, 2025

(51) Int. Cl. H04L 5/00; H04W 72/25

(52) U.S. Cl. CPC H04L 5/0048; H04W 72/25

(57) ABSTRACT

A method for inter-UE coordination based on a sidelink, including: receiving first information transmitted by a second user equipment, where the first information is configured to trigger an inter-UE coordination (IUC) function; and transmitting second information to a network device in a case where the first user equipment is in a first resource allocation mode, where the second information is configured to request the network device to configure the first user equipment to be in a second resource allocation mode.

### CROSS-REFERENCE TO RELATED APPLICATIONS

The present application is a U.S. National Stage of International Application No. PCT/CN2022/111261, filed on Aug. 9, 2022, the contents of all of which are incorporated herein by reference in their entireties for all purposes.

### BACKGROUND OF THE INVENTION

In order to support inter-user equipment (UE) direct communication, a sidelink (SL) communication method is introduced. One user equipment can communicate with a base station through a relay function of another user equipment, instead of being directly connected to a base station. An inter-UE interface is proximity communication (PC) 5. Two resource allocation modes exist in the SL communication method. One is a network dynamic scheduling mode (that is, mode 1). The other one is a UE autonomous selection mode (that is, mode 2) in a network broadcast resource pool. In the network dynamic scheduling mode, a network device dynamically allocates transmission resources on a sidelink (SL) to UE according to a buffer data report from the UE. In the autonomous selection mode, UE randomly selects transmission resources from a network broadcast or pre-configured resource pool. In some versions of communication protocols, an inter-UE coordination (IUC) function is introduced. The IUC function supports user equipment-A (UE-A) in mode 2 to transmit inter-UE coordination media access control (MAC) control elements (CE) (IUC MAC CE) information to peer user equipment-B (UE-B) in mode 2. The IUC MAC CE information can assist the peer UE-B in resource selection.

### SUMMARY OF THE INVENTION

The present disclosure relates to the technical field of communication, and particularly relates to a method for inter-UE coordination based on a sidelink, a device, and a storage medium.

In a first aspect, an embodiment of the present disclosure provides a method for inter-UE coordination based on a sidelink. The method is performed by first user equipment, and includes: receiving first information transmitted by a second user equipment, where the first information is configured to trigger an inter-UE coordination (IUC) function; and transmitting second information to a network device in a case where the first user equipment is in a first resource allocation mode, where the second information is configured to request the network device to configure the first user equipment to be in a second resource allocation mode.

In a second aspect, an embodiment of the present disclosure provides another method for inter-UE coordination based on a sidelink. The method is performed by a second user equipment, and includes: transmitting first information to a first user equipment. The first information is configured to trigger an inter-UE coordination (IUC) function.

In a third aspect, an embodiment of the present disclosure provides another method for inter-UE coordination based on a sidelink. The method is performed by a network device, and includes:
receiving second information transmitted by a first user equipment. The second information is configured to request the first user equipment to be configured to be in a second resource allocation mode.

In a fourth aspect, an embodiment of the present disclosure provides a communication device. The communication device includes a processor and a memory. A computer program is stored in the memory. The computer program stored in the memory is executed by the processor, such that the method for inter-UE coordination based on a sidelink described in the first aspect mentioned above is performed by the communication device.

In a fifth aspect, an embodiment of the present disclosure provides a non-transitory computer-readable storage medium. The computer-readable storage medium is used for storing instructions which are to be used by the above first user equipment. When the instructions are executed, the method for inter-UE coordination based on a sidelink described in the first aspect mentioned above is performed by the first user equipment.

### BRIEF DESCRIPTION OF DRAWINGS

In order to more clearly explain the technical solutions in the embodiments of the present disclosure or in the background art, the accompanying drawings required to be used in the embodiments of the present disclosure or in the background art will be described below.

FIG. 1 is a schematic architecture diagram of a communication system according to an embodiment of the present disclosure;

FIG. 2 is a schematic flowchart of a method for inter-UE coordination based on a sidelink according to an embodiment of the present disclosure;

FIG. 3 is a schematic flowchart of a method for inter-UE coordination based on a sidelink according to an embodiment of the present disclosure;

FIG. 4 is a schematic flowchart of another method for inter-UE coordination based on a sidelink according to an embodiment of the present disclosure;

FIG. 5 is a schematic flowchart of yet another method for inter-UE coordination based on a sidelink according to an embodiment of the present disclosure;

FIG. 6 is a schematic flowchart of yet another method for inter-UE coordination based on a sidelink according to an embodiment of the present disclosure;

FIG. 7 is a schematic flowchart of yet another method for inter-UE coordination based on a sidelink according to an embodiment of the present disclosure;

FIG. 8 is a schematic flowchart of yet another method for inter-UE coordination based on a sidelink according to an embodiment of the present disclosure;

FIG. 9 is a schematic flowchart of yet another method for inter-UE coordination based on a sidelink according to an embodiment of the present disclosure;

FIG. 10 is a schematic flowchart of still another method for inter-UE coordination based on a sidelink according to an embodiment of the present disclosure;

FIG. 11 is a schematic structural diagram of a communication device according to an embodiment of the present disclosure;

FIG. 12 is a schematic structural diagram of another communication device according to an embodiment of the present disclosure; and

FIG. 13 is a schematic structural diagram of a chip according to an embodiment of the present disclosure.

### DETAILED DESCRIPTION OF THE INVENTION

Examples will be described in detail here, and are illustratively stated in accompanying drawings. When the following descriptions involve accompanying drawings, unless otherwise stated, the same numerals in different accompanying drawings denote the same or similar elements. The implementations described in the following examples do not denote all implementations consistent with embodiments of the present disclosure. On the contrary, the implementations are merely instances of devices and methods consistent with some aspects of embodiments of the present disclosure as detailed in the appended claims.

Terms used in embodiments of the present disclosure are merely used for describing particular embodiments, and are not intended to limit embodiments of the present disclosure. Singular forms such as “a”, “an”, and “the” used in embodiments of the present disclosure and the appended claims are also intended to include plural forms, unless otherwise clearly stated in the context. It should also be understood that the term “and/or” used here refers to and includes any or all possible combinations of one or more of associated listed items.

It should be understood that although terms such as first, second and third may be used in embodiments of the present disclosure to describe various types of information, such information should not be limited to these terms. These terms are merely used for distinguishing the same type of information from each other. For example, without departing from the scope of embodiments of the present disclosure, first information can also be referred to as second information. Similarly, second information can also be referred to as first information. Depending on the context, the word “if” as used here may be interpreted as “in a case of”, “in a case where” or “in response to determining”.

For ease of understanding, terms involved in the present disclosure will be first introduced.
1. Cell (mobile communication term)

A cell, which may alternatively be referred to as a cellular cell, refers to an area covered by a base station or a part (a fan antenna) of a base station in a cellular mobile communication system. In this area, a mobile station can be reliably in communication with the base station through a radio channel. In a cell, one or more beams may exist.
2. A sidelink is a technology that a terminal is directly connected to another terminal by using new ratio (NR) spectrum resources and an access technology such that data transmission of an application layer can be carried out. A terminal may be a user equipment, which is not limited in the present disclosure.
3. Radio resource control (RRC) refers to radio resource management, control, and scheduling through set strategies and means. Limited radio network resources are fully used as much as possible while requirements of quality of service are satisfied. A planned coverage area can be ensured to be achieved. A service capacity and a resource utilization rate can be improved as much as possible.

In order to better understand a method for inter-UE coordination based on a sidelink disclosed in an embodiment of the present disclosure, a communication system to which an embodiment of the present disclosure is applicable will be first described below.

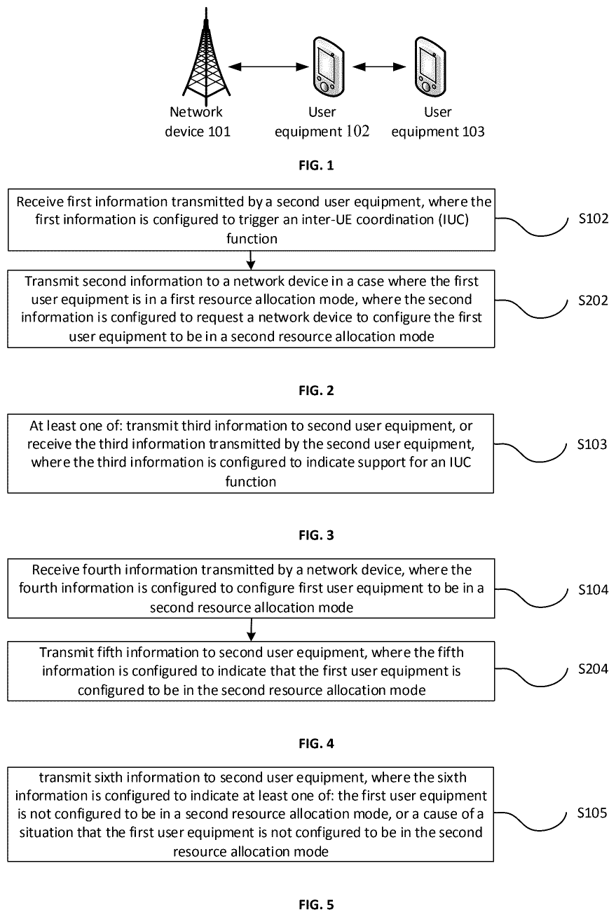

With reference to FIG. 1, a schematic architecture diagram of a communication system according to an embodiment of the present disclosure is shown in FIG. 1. The communication system may include but is not limited to one network device and two pieces of user equipment. Number and form of the device shown in FIG. 1 are merely used as instances and do not constitute limitations on embodiments of the present disclosure. During actual application, two or more network devices, and one piece of user equipment or two or more pieces of user equipment may be included. The communication system shown in FIG. 1, for example, includes one network device 101, and two pieces of user equipment 102 and 103.

It should be noted that the technical solutions of embodiments of the present disclosure can be applied to various communication systems, such as: a long term evolution (LTE) system, a 5th generation (5G) mobile communication system, a 5G new radio (NR) system, and other future novel mobile communication systems.

The network device 101 in an embodiment of the present disclosure is a network-side entity for transmitting or receiving signals. For example, the network device 101 may be an evolved node B (eNB), a transmission reception point (TRP), a next generation node B (gNB) in a new radio (NR) system, a base station in other future mobile communication systems, or an access node in a wireless fidelity (WiFi) system. A specific technology and specific device form used for the network device are not limited in embodiments of the present disclosure.

The network device provided in an embodiment of the present disclosure may include a central unit (CU) and a distributed unit (DU). The CU may alternatively be referred to as a control unit. By using a CU-DU structure, protocol layers of the network device such as a base station can be split. Functions of some protocol layers are controlled by the CU in a centralized manner. Functions of some or all of the remaining protocol layers are distributed in the DU. The DU is controlled by the CU in a centralized manner.

The user equipment 102 and 103 in an embodiment of the present disclosure are user-side entities for receiving or transmitting signals, such as mobile phones. The user equipment may alternatively be referred to as a terminal, user equipment (UE), a mobile station (MS), a mobile terminal (MT), etc. The user equipment may be an automobile having a communication function, a smart automobile, a mobile phone, a wearable device, a portable android device (Pad), a computer having a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc.

A specific technology and specific device form used for the user equipment are not limited in embodiments of the present disclosure.

It can be understood that the communication system described in embodiments of the present disclosure is used for more clearly explain the technical solutions of the embodiments of the present disclosure, and do not constitute a limitation on the technical solutions provided in the embodiments of the present disclosure. Those of ordinary skill in the art can know that as system architectures evolve and new service scenarios appear, the technical solutions provided in the embodiments of the present disclosure are also applicable to similar technical problems.

In a related technology, based on the SL communication method, if UE in mode 1 receives a trigger request message for the IUC function transmitted by peer UE, effective execution of the inter-UE coordination (IUC) function will be affected, resulting in a poor effect on inter-UE coordination based on a sidelink.

Embodiments of the present disclosure provide a method for inter-UE coordination based on a sidelink, an apparatus, a device, a chip system, a storage medium, a computer program, and a computer program product, which can be applied to the technical field of communication such that an inter-UE coordination (IUC) function can be ensured to be effectively performed, and an effect of the inter-UE coordination based on a sidelink can be improved.

The method for inter-UE coordination based on a sidelink, and a device provided in the present disclosure will be introduced in detail below in combination with accompanying drawings. FIG. 2 is a schematic flowchart of a method for inter-UE coordination based on a sidelink according to an embodiment of the present disclosure. The method is performed by first user equipment. The method for inter-UE coordination based on a sidelink in the embodiment may be applied to user equipment, such as a mobile phone and a tablet, smart watch, smart car having a mobile communication function, which is not limited.

As shown in FIG. 2, the method may include but is not limited to the following steps.
S102: first information transmitted by a second user equipment is received. The first information is configured to trigger an inter-UE coordination (IUC) function.

In the method for inter-UE coordination based on a sidelink provided in an embodiment of the present disclosure, a PC5 connection may be established between the second user equipment and the first user equipment in advance. The second user equipment and the first user equipment both support sidelink (SL) communication.

The first information transmitted by the second user equipment may be received by the first user equipment. The first information is configured to trigger the inter-UE coordination (IUC) function.

That is, information for triggering the IUC function may be transmitted by the second user equipment to the first user equipment. The information may be referred to as first information. Thus, the IUC function between the first user equipment and the second user equipment can be triggered based on the first information.

The second user equipment may transmit the first information to the first user equipment based on a sidelink (SL). The first user equipment may receive the first information transmitted by the second user equipment and trigger subsequent steps.
S202: second information is transmitted to a network device in a case where the first user equipment is in a first resource allocation mode. The second information is configured to request a network device to configure the first user equipment to be in a second resource allocation mode.

In the method for inter-UE coordination based on a sidelink provided in an embodiment of the present disclosure, the first user equipment may be in an RRC connected state. The resource allocation mode configured for a network is a network dynamic scheduling mode (mode 1). After receiving the first information, the first user equipment requests, by using the second information, a network device side to configure the first user equipment to be in a second resource allocation mode (mode 2).

After receiving the first information transmitted by the second user equipment, the first user equipment can determine the resource allocation mode (of the first user equipment). Then, if the resource allocation mode is determined as the first resource allocation mode (the first resource allocation mode is mode 1: the network dynamic scheduling mode), and in the first resource allocation mode, the network device dynamically allocates transmission resources on a sidelink (SL) to UE according to a buffer data report from the UE, the network device may be requested to configure the first user equipment to be in the second resource allocation mode (the second resource allocation mode is mode 2: an autonomous selection mode), and in the second resource allocation mode, UE randomly selects transmission resources from a network broadcast by or pre-configured resource pool). The information configured to request the first user equipment to be configured to be in the second resource allocation mode may be referred to as the second information.

That is, according to the method for inter-UE coordination based on a sidelink in embodiments of the present disclosure, subsequent actions possibly used are provided after the UE in mode 1 receives the information for triggering the inter-UE coordination (IUC) function transmitted by peer UE. That is, if the first user equipment is in the first resource allocation mode, the first user equipment transmit the second information to the network device. The second information is configured to request the network device to configure the first user equipment to be in the second resource allocation mode. Thus, the inter-UE coordination (IUC) function can be ensured to be effectively performed, and an effect of the inter-UE coordination based on a sidelink can be improved.

In the embodiment, by receiving first information transmitted by second user equipment, where the first information is configured to trigger an inter-UE coordination (IUC) function, if the first user equipment is in a first resource allocation mode, the second information is transmitted to a network device, where the second information is configured to request the network device to configure the first user equipment to be in a second resource allocation mode. Thus, the inter-UE coordination (IUC) function can be ensured to be effectively performed, and an effect of the inter-UE coordination based on a sidelink can be improved.

An embodiment of the present disclosure provides a method for inter-UE coordination based on a sidelink. The first information includes at least one of: inter-UE coordination media access control control elements (IUC MAC CE) information, inter-UE coordination request media access control control elements (IUC request MAC CE) information, or PC5 interface-radio resource control (PC5-RRC) configuration information. The PC5-RRC configuration information includes a latency bound. The latency bound is configured to control transmission time of the IUC MAC CE information.

That is, in embodiments of the present disclosure, a case that the inter-UE coordination (IUC) function is triggered by using any one type of the above first information is supported.

For example, IUC MAC CE information transmitted by the second user equipment is received, where the IUC MAC CE information is configured to trigger the inter-UE coordination (IUC) function; or IUC request MAC CE information transmitted by the second user equipment is received, where the IUC request MAC CE information is configured to trigger the inter-UE coordination (IUC) function; or PC5-RRC configuration information transmitted by the second user equipment is received, where the PC5-RRC configuration information is configured to trigger the inter-UE coordination (IUC) function, which is not limited.

The IUC MAC CE information may carry a preferred resource set or a non-preferred resource set to assist peer UE-B in resource selection. If the IUC MAC CE information carries a preferred resource set, UE-B transmits data to UE-A by using the preferred resource set. If the IUC MAC CE information carries a non-preferred resource set, when UE-B transmits data to UE-A, resources indicated by the non-preferred resource set cannot be used.

The IUC function has two trigger modes, that is, a request-based IUC mechanism and a condition-based IUC mechanism. The request-based IUC mechanism means that UE-A transmits the IUC MAC CE information after receiving a request transmitted by UE-B through PC-5. The condition-based IUC mechanism means that UE-A determines whether a trigger condition is satisfied. If the trigger condition is satisfied, UE-A can choose, based on an implementation, to automatically trigger transmission of the IUC MAC CE information. The request-based IUC mechanism may restrict, by configuring a latency bound, peer UE to transmitting IUC MAC CE information within the latency bound. The latency bound is not applicable to a conditional triggered IUC mechanism. An UE can configure a latency bound for peer UE by using a PC5-RRC signaling.

The IUC request MAC CE information is request information for requesting the IUC function to be triggered in the above request-based IUC mechanism.

The PC5-RRC configuration information may be information for configuring a latency bound of the first user equipment transmitted by the second user equipment to the first user equipment.

An embodiment of the present disclosure provides a method for inter-UE coordination based on a sidelink. IUC MAC CE information may carry a preferred resource set or a non-preferred resource set.

An embodiment of the present disclosure provides a method for inter-UE coordination based on a sidelink. IUC MAC CE information is IUC MAC CE information triggered based condition.

An embodiment of the present disclosure provides a method for inter-UE coordination based on a sidelink. An IUC latency bound in PC5-RRC configuration information is a mandatory parameter.

An embodiment of the present disclosure provides a method for inter-UE coordination based on a sidelink, the step that second information is transmitted to a network device includes at least one of: a sidelink UE information (SUI) signaling is transmitted to the network device, where the SUI signaling includes the second information; or a UE assistance information (UAI) signaling is transmitted to the network device, where the UAI signaling includes the second information. Thus, indication flexibility of the second information can be effectively improved, no additional indication overhead will be occupied, and indication efficiency of the second information can be improved.

In the sidelink (SL) communication method, reporting of sidelink UE information (SUI) is supported. The sidelink UE information (SUI) is assistance information transmitted between the UE and the network device. The UE in a connected state may report the assistance information by using the sidelink UE information (SUI) signaling, so as to assist a network device side in resource configuration, signaling radio bearer (SRB)/data radio bearer (DRB) configuration, etc. The UE in the connected state may report the assistance information by using the UE assistance information (UAI) signaling. If the assistance information is reported by using the UAI signaling, the network device side is generally required to be enabled based on an RRC signaling first.

That is, an embodiment of the present disclosure provides a method for inter-UE coordination based on a sidelink. The first user equipment in mode 1 may receive IUC MAC CE information, IUC request MAC CE information, or PC5-RRC configuration information carrying a latency bound transmitted by the second user equipment, and transmit information (that is, second information) to a network device by using the sidelink UE information (SUI) signaling or the UE assistance information (UAI) signaling, so as to request a network to configure mode 2.

For example, the second information may be transmitted to the network device based on a first signaling bearer. The first signaling bearer may be an SUI signaling. After receiving the first information, the first user equipment determines itself to be currently in resource allocation mode 1 and supports the IUC function, the second information can be carried by the SUI signaling and reported to the network device. Or, the first signaling bearer may be a UAI signaling. The network device side configures and enables the first user equipment such that the first user equipment can report the second information by using the UAI signaling. After receiving the first information, the first user equipment determines itself to be currently in resource allocation mode 1 and supports the IUC function, the second information can be carried by the UAI signaling and reported to the network device.

FIG. 3 is a schematic flowchart of a method for inter-UE coordination based on a sidelink according to an embodiment of the present disclosure. The method is performed by first user equipment.

As shown in FIG. 3, the method may include but is not limited to the following steps.
S103: at least one of: third information is transmitted to second user equipment, or the third information transmitted by the second user equipment is received. The third information is configured to indicate support for an IUC function.

The information indicating support for an IUC function may be referred to as third information.

In a case where the first user equipment transmits the third information to the second user equipment, the third information is configured to indicate that the first user equipment supports the IUC function. In a case where the first user equipment receives the third information transmitted by the second user equipment, the third information can be configured to indicate that the second user equipment supports the IUC function, which is not limited.

That is, in embodiments of the present disclosure, UE capabilities may interact between the second user equipment and the first user equipment by using PC5-RRC configuration information, so as to indicate to peer UE that the UE supports an IUC feature.

In the embodiment, by at least one of: transmitting the third information to the second user equipment, or receiving the third information transmitted by the second user equipment, where the third information is configured to indicate support for an IUC function, completeness of the method for inter-UE coordination based on a sidelink can be improved, and comprehensiveness of indication can be improved.

An embodiment of the present disclosure provides a method for inter-UE coordination based on a sidelink. The second information includes at least one of: second resource allocation mode request information; or a latency bound. The latency bound is configured to control transmission time of IUC MAC CE information. Thus, completeness of the second information can be improved, and it can be accurately requested that the first user equipment is configured to be in the second resource allocation mode.

For example, the second information may include at least one of: a resource allocation mode 2 request (that is, second resource allocation mode request information), or an IUC latency bound (a latency bound configured for the IUC function).

For example, the resource allocation mode 2 request (the second resource allocation mode request information) may be indicated based on an enable indication bit of 1 bit such that it can be explicitly indicated based on the indication bit that the network device is requested to configure the first user equipment (UE) to be in resource allocation mode 2. Or, it can be indicated through an implicit indication method to the network device that the network device is requested to configure the first user equipment (UE) to be in the resource allocation mode 2.

For example, the IUC latency bound (a latency bound configured for the IUC function) included in the second information may be a latency bound received based on the PC5-RRC configuration information.

FIG. 4 is a schematic flowchart of another method for inter-UE coordination based on a sidelink according to an embodiment of the present disclosure. The method is performed by first user equipment.

As shown in FIG. 4, the method may include but is not limited to the following steps.
S104: fourth information transmitted by a network device is received. The fourth information is configured to configure first user equipment to be in a second resource allocation mode.

After the first user equipment is determined to be in the first resource allocation mode and the second information is transmitted to the network device, the fourth information transmitted by the network device may be received. The fourth information is configured to configure the first user equipment to be in the second resource allocation mode.

That is, the first user equipment requests, based on the second information, the network device to configure the first user equipment to be in the second resource allocation mode. The network device may issue, in response to the second information, information for configuring the first user equipment to be in the second resource allocation mode to the first user equipment. The information may be referred to as fourth information.
S204: fifth information is transmitted to second user equipment. The fifth information is configured to indicate that the first user equipment is configured to be in the second resource allocation mode.

The first user equipment may receive the fourth information transmitted by the network device. In response to receiving the fourth information, the first user equipment is configured to be switched from being in the first resource allocation mode to the second resource allocation mode. Then, information indicating that the first user equipment is configured to be in the second resource allocation mode may be transmitted to the second user equipment. The information may be referred to as fifth information. Thus, the second user equipment can timely learn that the first user equipment is configured to be in the second resource allocation mode.

In the embodiment, by at least one of: receiving the fourth information transmitted by the network device, or transmitting the fifth information to the second user equipment, where the fourth information is configured to configure the first user equipment to be in the second resource allocation mode, where the fifth information is configured to indicate that the first user equipment is configured to be in the second resource allocation mode, the first user equipment can be timely configured to be in the second resource allocation mode, and the second user equipment can be timely informed that it is configured to be in the second resource allocation mode. An effect of the inter-UE coordination based on a sidelink can be effectively improved.

An embodiment of the present disclosure provides a method for inter-UE coordination based on a sidelink. The step that the fifth information is transmitted to second user equipment includes: a sidelink radio resource control (RRC) reconfiguration completion message is transmitted to the second user equipment. The RRC reconfiguration completion message is used as the fifth information. The first information is PC5-RRC configuration information. The PC5-RRC configuration information includes a latency bound. The latency bound is configured to control transmission time of IUC MAC CE information. Thus, indication overhead can be effectively reduced while an indication effect can be effectively improved.

For example, the sidelink radio resource control (RRC) reconfiguration completion message may be an RRC reconfiguration complete sidelink message.

The RRC reconfiguration complete sidelink message may be configured to indicate to the second user equipment that the first user equipment is configured to be in the second resource allocation mode.

For example, when the first user equipment receives a reconfiguration message (fourth information) from a network device side, the first user equipment may reply to the second user equipment with an RRC reconfiguration complete sidelink message, or the first user equipment may transmit data to the second user equipment by using a resource indicated through IUC, or the first user equipment may transmit data to the second user equipment by using a resource indicated through non-IUC, or the first user equipment may generate an IUC message and transmit the IUC message to peer second user equipment, which is not limited.

For example, the first information is PC5-RRC configuration information carrying an IUC latency bound. A reconfiguration message of the network device side configures the resource allocation mode of the first user equipment to be mode 2. After receiving the reconfiguration message, the first user equipment may reply with the RRC reconfiguration complete sidelink message by using the PC5-RRC configuration information.

An embodiment of the present disclosure provides a method for inter-UE coordination based on a sidelink. The method may further include: data is transmitted to second user equipment based on a preferred resource set. The first information is IUC MAC CE information. The IUC MAC CE information includes the preferred resource set. Completeness of the method for inter-UE coordination based on a sidelink can be effectively improved, and accuracy and completeness of execution of the IUC function can be ensured.

For example, the first information is IUC MAC CE information. The IUC MAC CE information carries a preferred resource set. The reconfiguration message of the network device side configures the resource allocation mode of the first user equipment to be mode 2. After receiving the reconfiguration message, the first user equipment may transmit data to the second user equipment by using the preferred resource set.

An embodiment of the present disclosure provides a method for inter-UE coordination based on a sidelink. The method may further include: data is transmitted to second user equipment based on a resource. The first information is IUC MAC CE information. The IUC MAC CE information includes a non-preferred resource set. The resource does not belong to the non-preferred resource set. Completeness of the method for inter-UE coordination based on a sidelink can be effectively improved, and accuracy and completeness of execution of the IUC function can be ensured.

For example, the first information is IUC MAC CE information. The IUC MAC CE information carries a non-preferred resource set. The reconfiguration message of the network device side configures the resource allocation mode of the first user equipment to be mode 2. After receiving the reconfiguration message, the first user equipment does not transmit data to the second user equipment by using the non-preferred resource set, but may transmit data to the second user equipment by using other resources, which is not limited.

An embodiment of the present disclosure provides a method for inter-UE coordination based on a sidelink. The method may further include: IUC MAC CE information is transmitted to second user equipment. The IUC MAC CE information includes a preferred resource set or a non-preferred resource set. The first information is IUC request MAC CE information. Completeness of the method for inter-UE coordination based on a sidelink can be effectively improved, and accuracy and completeness of execution of the IUC function can be ensured.

For example, in a case where the first information is IUC request MAC CE information, the reconfiguration message of the network device side configures the resource allocation mode of the first user equipment to be mode 2. After receiving the reconfiguration message, the first user equipment may transmit the IUC MAC CE information to the second user equipment. The IUC MAC CE information includes a preferred resource set or a non-preferred resource set, which is not limited.

FIG. 5 is a schematic flowchart of another method for inter-UE coordination based on a sidelink according to an embodiment of the present disclosure. The method is performed by first user equipment.

As shown in FIG. 5, the method may include but is not limited to the following steps.
S105: sixth information is transmitted to second user equipment. The sixth information is configured to indicate at least one of: the first user equipment is not configured to be in a second resource allocation mode, or a cause of a situation that the first user equipment is not configured to be in the second resource allocation mode.

The first user equipment may receive the fourth information transmitted by the network device. Moreover, in response to receiving the fourth information, where the fourth information does not include a configuration for configuring the first user equipment to be in the second resource allocation mode, the first user equipment may transmit information indicating that the first user equipment is not configured to be in the second resource allocation mode to the second user equipment. The information may be referred to as sixth information.

In some other embodiments, the sixth information may further carry a cause of a situation that the first user equipment is not configured to be in the second resource allocation mode.

An embodiment of the present disclosure provides a method for inter-UE coordination based on a sidelink. A sidelink radio resource control (RRC) reconfiguration failure message is transmitted to second user equipment. The RRC reconfiguration failure message is used as sixth information. The first information is PC5-RRC configuration information. The PC5-RRC configuration information includes a latency bound. The latency bound is configured to control transmission time of IUC MAC CE information.

For example, if the reconfiguration message received by the first user equipment does not include a configuration for configuring the first user equipment to be in the second resource allocation mode, the first user equipment may reply to the second user equipment with an RRC reconfiguration failure sidelink message (RRC reconfiguration failure message). The RRC reconfiguration failure message may carry a cause value.

In the embodiment, by transmitting the sixth information to the second user equipment, where the sixth information is configured to indicate at least one of: the first user equipment is not configured to be in the second resource allocation mode, or a cause of a situation that the first user equipment is not configured to be in the second resource allocation mode, the second user equipment can timely learn a relevant situation that the first user equipment is not configured to be in the second resource allocation mode, and the second user equipment can take solutions.

An embodiment of the present disclosure provides a method for inter-UE coordination based on a sidelink. Elapsed time after the second information is transmitted to the network device may be determined. If the elapsed time reaches a time threshold and the fourth information transmitted by the network device is not received, the sixth information is transmitted to the second user equipment. The fourth information is configured to configure the first user equipment to be in the second resource allocation mode. Flexibility of inter-UE coordination can be improved, resources of the second user equipment can be effectively prevented from being occupied, and the second user equipment can timely take solutions.

For example, the first information is PC5-RRC configuration information carrying an IUC latency bound. The first user equipment transmits the second information. If a reconfiguration message that a resource allocation mode configured by a network device side is mode 2 is not received within a period of time, the first user equipment may reply with an RRC reconfiguration failure sidelink message (RRC reconfiguration failure message) by using the PC5-RRC. The RRC reconfiguration failure message may carry a cause value. The cause value may be configured to indicate that the first user equipment is in mode 1 or indicate that the first user equipment does not support an IUC feature (provided that no IUC capability interacts during capability interaction). The above “period of time”may be configured by a network side or UE, which is not limited.

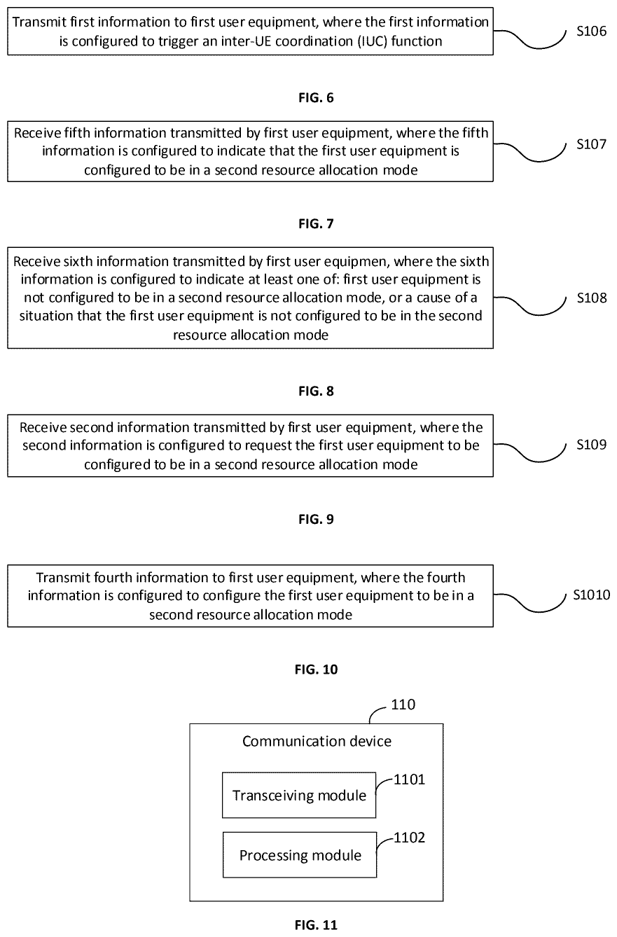

FIG. 6 is a schematic flowchart of another method for inter-UE coordination based on a sidelink according to an embodiment of the present disclosure. The method is performed by second user equipment.

As shown in FIG. 6, the method may include but is not limited to the following steps.
S106: first information is transmitted to first user equipment. The first information is configured to trigger an inter-UE coordination (IUC) function.

That is, information for triggering the IUC function may be transmitted by the second user equipment to the first user equipment. The information may be referred to as first information. Thus, the IUC function between the first user equipment and the second user equipment can be triggered based on the first information.

The second user equipment may transmit the first information to the first user equipment based on a sidelink (SL). The first user equipment may receive the first information transmitted by the second user equipment and trigger subsequent steps.

In the embodiment, by transmitting the first information to the first user equipment, where the first information is configured to trigger the inter-UE coordination (IUC) function, the inter-UE coordination (IUC) function can be effectively performed, and an effect of the inter-UE coordination based on a sidelink can be improved.

An embodiment of the present disclosure provides a method for inter-UE coordination based on a sidelink. The first information includes at least one of: inter-UE coordination media access control control elements (IUC MAC CE) information, inter-UE coordination request media access control control elements (IUC request MAC CE) information, or PC5 interface-radio resource control (PC5-RRC) configuration information. The PC5-RRC configuration information includes a latency bound. The latency bound is configured to control transmission time of the IUC MAC CE information. Thus, configuration flexibility of the first information can be effectively improved.

That is, in embodiments of the present disclosure, a case that the IUC function of the first user equipment is triggered by using any one type of the above first information is supported.

For example, IUC MAC CE information may be transmitted to the first user equipment, where the IUC MAC CE information is configured to trigger the inter-UE coordination (IUC) function; or IUC request MAC CE information may be transmitted to the first user equipment, where the IUC request MAC CE information is configured to trigger the inter-UE coordination (IUC) function; or PC5-RRC configuration information may be transmitted to the first user equipment, where the PC5-RRC configuration information is configured to trigger the inter-UE coordination (IUC) function, which is not limited.

An embodiment of the present disclosure provides a method for inter-UE coordination based on a sidelink. The method further includes at least one of: the third information is transmitted to the first user equipment, or the third information transmitted by the first user equipment is received. The third information is configured to indicate support for the IUC function. Completeness of the method for inter-UE coordination based on a sidelink can be improved, and comprehensiveness of indication can be improved.

FIG. 7 is a schematic flowchart of another method for inter-UE coordination based on a sidelink according to an embodiment of the present disclosure. The method is performed by second user equipment.

As shown in FIG. 7, the method may include but is not limited to the following steps.
S107: fifth information transmitted by first user equipment is received. The fifth information is configured to indicate that the first user equipment is configured to be in a second resource allocation mode.

The first user equipment may receive the fourth information transmitted by the network device. In response to receiving the fourth information, the first user equipment is configured to be switched from being in the first resource allocation mode to the second resource allocation mode. Then, information indicating that the first user equipment is configured to be in the second resource allocation mode may be transmitted to the second user equipment. The information may be referred to as fifth information. Thus, the second user equipment can timely learn that the first user equipment is configured to be in the second resource allocation mode.

In the embodiment, by receiving the fifth information transmitted by the first user equipment, where the fifth information is configured to indicate that the first user equipment is configured to be in the second resource allocation mode, it can be timely learned that the first user equipment is configured to be in the second resource allocation mode, and an effect of inter-UE coordination based on a sidelink can be effectively improved.

An embodiment of the present disclosure provides a method for inter-UE coordination based on a sidelink. The step that fifth information is transmitted to first user equipment includes: a sidelink radio resource control (RRC) reconfiguration completion message is transmitted to the first user equipment. The RRC reconfiguration completion message is used as the fifth information. The first information is PC5-RRC configuration information. The PC5-RRC configuration information includes a latency bound. The latency bound is configured to control transmission time of IUC MAC CE information. Thus, indication overhead can be effectively reduced while an indication effect can be effectively improved.

An embodiment of the present disclosure provides a method for inter-UE coordination based on a sidelink. The method may further include: data transmitted by the first user equipment is received. The transmitted data is transmitted based on a preferred resource set. The first information is IUC MAC CE information. The IUC MAC CE information includes the preferred resource set. Completeness of the method for inter-UE coordination based on a sidelink can be effectively improved, and accuracy and completeness of execution of the IUC function can be ensured.

An embodiment of the present disclosure provides a method for inter-UE coordination based on a sidelink. The method may further include: data transmitted by the first user equipment is received. The transmitted data is transmitted based on a resource. The first information is IUC MAC CE information. The IUC MAC CE information includes a non-preferred resource set. The resource does not belong to the non-preferred resource set. Completeness of the method for inter-UE coordination based on a sidelink can be effectively improved, and accuracy and completeness of execution of the IUC function can be ensured.

An embodiment of the present disclosure provides a method for inter-UE coordination based on a sidelink. The method further includes: IUC MAC CE information transmitted by the first user equipment is received. The IUC MAC CE information includes a preferred resource set or a non-preferred resource set. The first information is IUC request MAC CE information. Completeness of the method for inter-UE coordination based on a sidelink can be effectively improved, and accuracy and completeness of execution of the IUC function can be ensured.

FIG. 8 is a schematic flowchart of another method for inter-UE coordination based on a sidelink according to an embodiment of the present disclosure. The method is performed by second user equipment.

As shown in FIG. 8, the method may include but is not limited to the following steps.
S108: sixth information transmitted by first user equipment is received. The sixth information is configured to indicate at least one of: the first user equipment is not configured to be in a second resource allocation mode, or a cause of a situation that the first user equipment is not configured to be in the second resource allocation mode.

In the embodiment, by receiving the sixth information transmitted by the first user equipment, where the sixth information is configured to indicate at least one of: the first user equipment is not configured to be in the second resource allocation mode, or a cause of a situation that the first user equipment is not configured to be in the second resource allocation mode, the second user equipment can timely learn a relevant situation that the first user equipment is not configured to be in the second resource allocation mode, and the second user equipment can take solutions.

An embodiment of the present disclosure provides a method for inter-UE coordination based on a sidelink. The step that the sixth information transmitted by the first user equipment is received includes: a sidelink radio resource control (RRC) reconfiguration failure message transmitted by first user equipment is received. The RRC reconfiguration failure message is used as sixth information. The first information is PC5-RRC configuration information. The PC5-RRC configuration information includes a latency bound. The latency bound is configured to control transmission time of IUC MAC CE information.

FIG. 9 is a schematic flowchart of another method for inter-UE coordination based on a sidelink according to an embodiment of the present disclosure. The method is performed by a network device. The network device may be a network device supporting sidelink (SL) communication.

As shown in FIG. 9, the method may include but is not limited to the following steps.
S109: second information transmitted by first user equipment is received. The second information is configured to request the first user equipment to be configured to be in a second resource allocation mode.

That is, according to the method for inter-UE coordination based on a sidelink in embodiments of the present disclosure, subsequent actions possibly used are provided after the UE in mode 1 receives the information for triggering the inter-UE coordination (IUC) function transmitted by peer UE are provided. That is, if the first user equipment is in the first resource allocation mode, the second information is transmitted to the network device. The second information is configured to request the network device to configure the first user equipment to be in the second resource allocation mode. Thus, the inter-UE coordination (IUC) function can be ensured to be effectively performed, and an effect of the inter-UE coordination based on a sidelink can be improved.

The network device may receive the second information transmitted by the first user equipment such that the first user equipment can be triggered, based on content indicated by the second information, to be configured to be in the second resource allocation mode.

In the embodiment, by receiving the second information transmitted by the first user equipment, where the second information is configured to request the first user equipment to be configured to be in the second resource allocation mode, the inter-UE coordination (IUC) function can be assisted to be effectively performed, and the effect of the inter-UE coordination based on a sidelink can be improved.

An embodiment of the present disclosure provides a method for inter-UE coordination based on a sidelink. The step that second information transmitted by first user equipment is received includes at least one of: an SUI signaling transmitted by the first user equipment is received, where the SUI signaling includes the second information; or a UAI signaling transmitted by the first user equipment is received, where the UAI signaling includes the second information. Thus, indication flexibility of the second information can be effectively improved, no additional indication overhead will be occupied, and indication efficiency of the second information can be improved.

An embodiment of the present disclosure provides a method for inter-UE coordination based on a sidelink. The second information includes at least one of: second resource allocation mode request information; or a latency bound. The latency bound is configured to control transmission time of IUC MAC CE information. Thus, completeness of the second information can be improved, and it can be accurately requested that the first user equipment is configured to be in the second resource allocation mode.

FIG. 10 is a schematic flowchart of still another method for inter-UE coordination based on a sidelink according to an embodiment of the present disclosure. The method is performed by a network device.

As shown in FIG. 10, the method may include but is not limited to the following steps.
S1010: fourth information is transmitted to first user equipment. The fourth information is configured to configure the first user equipment to be in a second resource allocation mode.

In response to the second information reported by the first user equipment, the network device may issue information for configuring the first user equipment to be in the second resource allocation mode to the first user equipment. The information may be referred to as fourth information.

In the embodiment, by transmitting the fourth information to the first user equipment, where the fourth information is configured to configure the first user equipment to be in the second resource allocation mode, the first user equipment can be timely configured to be in the second resource allocation mode.

FIG. 11 is a schematic structural diagram of a communication device according to an embodiment of the present disclosure. The communication device 110 shown in FIG. 11 may include a transceiving module 1101 and a processing module 1102. The transceiving module 1101 may include at least one of a transmitting module or a receiving module. The transmitting module is used for implementing a transmitting function. The receiving module is used for implementing a receiving function. The transceiving module 1101 may implement at least one of the transmitting function or the receiving function.

The communication device 110 may be user equipment (such as the first user equipment and the second user equipment in the foregoing method embodiments), a device included in the user equipment, or a device that can be used with the user equipment in a matching manner. Or, the communication device 110 may be a network device (such as the network device in the foregoing method embodiments), a device included in the network device, or a device that can be used with the network device in a matching manner.

The communication device 110, on a first user equipment side, includes:
a transceiving module 1101 configured to receive first information transmitted by second user equipment, where the first information is configured to trigger an inter-UE coordination (IUC) function; and
transmitting second information to a network device in a case where first user equipment is in a first resource allocation mode, where the second information is configured to request a network device to configure the first user equipment to be in a second resource allocation mode.

Optionally, the first information includes at least one of:
inter-UE coordination media access control control elements (IUC MAC CE) information;
inter-UE coordination request media access control control elements (IUC request MAC CE) information; or
PC5 interface-radio resource control (PC5-RRC) configuration information. The PC5-RRC configuration information includes a latency bound. The latency bound is configured to control transmission time of the IUC MAC CE information.

Optionally, the transceiving module 1101 is further configured to:
transmit a sidelink UE information (SUI) signaling to the network device, where the SUI signaling includes the second information; and
transmit a UE assistance information (UAI) signaling to the network device, where the UAI signaling includes the second information.

Optionally, the transceiving module 1101 is configured to at least one of:
transmit third information to second user equipment, or receive the third information transmitted by the second user equipment, where the third information is configured to indicate support for an IUC function.

Optionally, the second information includes at least one of:
second resource allocation mode request information; or
a latency bound. The latency bound is configured to control the transmission time of the IUC MAC CE information.

Optionally, the transceiving module 1101 is further configured to:
receive fourth information transmitted by a network device. The fourth information is configured to configure first user equipment to be in a second resource allocation mode.

Optionally, the transceiving module 1101 is further configured to:
transmit fifth information to second user equipment. The fifth information is configured to indicate that the first user equipment is configured to be in the second resource allocation mode.

Optionally, the transceiving module 1101 is further configured to:
transmit a sidelink radio resource control (RRC) reconfiguration completion message to the second user equipment.

The RRC reconfiguration completion message is used as the fifth information. The first information is PC5-RRC configuration information. The PC5-RRC configuration information includes a latency bound. The latency bound is configured to control transmission time of IUC MAC CE information.

Optionally, the transceiving module 1101 is further configured to:
transmit data to the second user equipment based on a preferred resource set, where the first information is IUC MAC CE information, and the IUC MAC CE information includes the preferred resource set;
transmit data to the second user equipment based on a resource, where the first information is IUC MAC CE information, the IUC MAC CE information includes a non-preferred resource set, and the resource does not belong to the non-preferred resource set; or
transmit IUC MAC CE information to the second user equipment, where the IUC MAC CE information includes a preferred resource set or a non-preferred resource set, and the first information is IUC request MAC CE information.

Optionally, the transceiving module 1101 is further configured to:
transmitting sixth information to the second user equipment. The sixth information is configured to indicate at least one of: the first user equipment is not configured to be in the second resource allocation mode, or a cause of a situation that the first user equipment is not configured to be in the second resource allocation mode.

Optionally, the device further includes:
a processing module 1102 configured to determine elapsed time after the second information is transmitted to the network device.

Optionally, the transceiving module 1101 is further configured to:
transmitting the sixth information to the second user equipment in a case where the elapsed time reaches a time threshold and fourth information transmitted by the network device is not received. The fourth information is configured to configure the first user equipment to be in the second resource allocation mode.

Optionally, the transceiving module 1101 is further configured to:
transmit a sidelink radio resource control (RRC) reconfiguration failure message to the second user equipment.

The RRC reconfiguration failure message is used as the sixth information. The first information is PC5-RRC configuration information. The PC5-RRC configuration information includes a latency bound. The latency bound is configured to control transmission time of IUC MAC CE information.

The communication device 110, on a second user equipment side, includes:
a transceiving module 1101 configured to transmit first information to first user equipment. The first information is configured to trigger an inter-UE coordination (IUC) function.

Optionally, the first information includes at least one of:
inter-UE coordination media access control control elements (IUC MAC CE) information;
inter-UE coordination request media access control control elements (IUC request MAC CE) information; or
PC 5 interface-radio resource control (PC5-RRC) configuration information. The PC5-RRC configuration information includes a latency bound. The latency bound is configured to control transmission time of the IUC MAC CE information.

Optionally, the transceiving module 1101 is further configured to at least one of:
transmit third information to first user equipment, or receive the third information transmitted by the first user equipment. The third information is configured to indicate support for an IUC function.

Optionally, the transceiving module 1101 is further configured to:
receive fifth information transmitted by first user equipment. The fifth information is configured to indicate that the first user equipment is configured to be in a second resource allocation mode.

Optionally, the transceiving module 1101 is further configured to:
receive a sidelink radio resource control (RRC) reconfiguration completion message transmitted by the first user equipment.

The RRC reconfiguration completion message is used as the fifth information. The first information is PC5-RRC configuration information. The PC5-RRC configuration information includes a latency bound. The latency bound is configured to control transmission time of IUC MAC CE information.

Optionally, the transceiving module 1101 is further configured to:
receive data transmitted by the first user equipment, where the transmitted data is transmitted based on a preferred resource set, the first information is IUC MAC CE information, and the IUC MAC CE information includes the preferred resource set;
receive data transmitted by the first user equipment, where the transmitted data is transmitted based on a resource, the first information is IUC MAC CE information, the IUC MAC CE information includes a non-preferred resource set, and the resource do not belong to the non-preferred resource set; or
receive IUC MAC CE information transmitted by the first user equipment, where the IUC MAC CE information includes a preferred resource set or a non-preferred resource set, and the first information is IUC request MAC CE information.

Optionally, the transceiving module 1101 is further configured to:
receive sixth information transmitted by first user equipment. The sixth information is configured to indicate at least one of: first user equipment is not configured to be in a second resource allocation mode, or a cause of a situation that the first user equipment is not configured to be in the second resource allocation mode.

Optionally, the transceiving module 1101 is further configured to:
receiving a sidelink radio resource control (RRC) reconfiguration failure message transmitted by the first user equipment.

The RRC reconfiguration failure message is used as the sixth information. The first information is PC5-RRC configuration information. The PC5-RRC configuration information includes a latency bound. The latency bound is configured to control transmission time of IUC MAC CE information.

The communication device 110, on a network device side, includes:
a transceiving module 1101 configured to receive second information transmitted by first user equipment. The second information is configured to request the first user equipment to be configured to be in a second resource allocation mode.

Optionally, the transceiving module 1101 is further configured to:
receive an SUI signaling transmitted by the first user equipment, where the SUI signaling includes the second information; and
receive a UAI signaling transmitted by the first user equipment, where the UAI signaling includes the second information.

Optionally, the second information includes at least one of:
second resource allocation mode request information; or
a latency bound. The latency bound is configured to control the transmission time of the IUC MAC CE information.

Optionally, the transceiving module 1101 is further configured to:
transmit fourth information to first user equipment. The fourth information is configured to configure the first user equipment to be in a second resource allocation mode.

In the embodiment, by receiving first information transmitted by second user equipment, where the first information is configured to trigger an inter-UE coordination (IUC) function, if the first user equipment is in a first resource allocation mode, second information is transmitted to a network device, where the second information is configured to request the network device to configure the first user equipment to be in a second resource allocation mode. Thus, the inter-UE coordination (IUC) function can be ensured to be effectively performed, and an effect of the inter-UE coordination based on a sidelink can be improved.

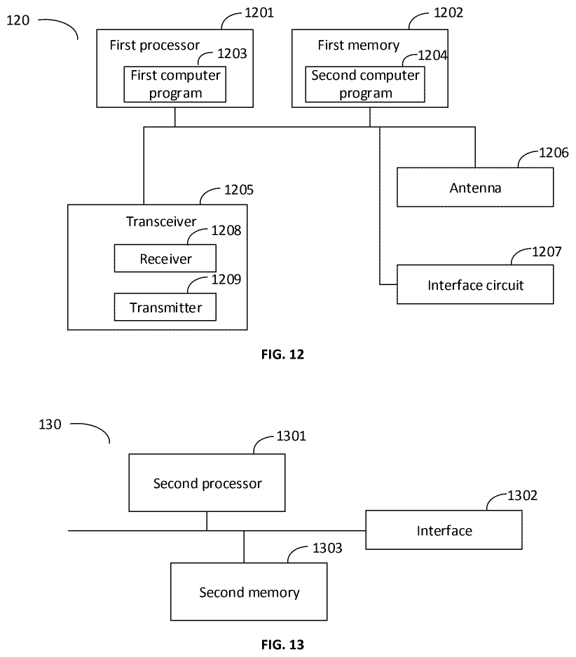

FIG. 12 is a schematic structural diagram of another communication device according to an embodiment of the present disclosure. The communication device 120 may be a network device (such as the network device in the foregoing method embodiments), user equipment (such as the first user equipment and the second user equipment in the foregoing method embodiments), a chip, chip system, or processor supporting the network device in implementation of the above method, or a chip, chip system, or processor supporting the user equipment in implementation of the above method. The device may be used for implementing the method described in the above method embodiments. Details can be obtained with reference to the descriptions in the above method embodiments.

The communication device 120 may include one or more first processors 1201. The first processor 1201 may be a general-purpose processor, a special-purpose processor, etc. For example, the processor may be a baseband processor or a central processing unit. The baseband processor may be used for processing a communication protocol and communication data. The central processing unit may be configured to control a communication device (such as a base station, a baseband chip, a terminal device, a terminal device chip, a distributed unit (DU), and a centralized unit (CU)), executing a computer program, and processing data of the computer program.

Optionally, the communication device 120 may further include one or more first memories 1202. Second Computer programs 1204 may be stored in the memories. A first computer program 1203 may be stored in the first processor 1201. The first processor 1201 executes the second computer program 1204 and/or the first computer program 1203, such that the communication device 120 performs the method described in the above method embodiments. Optionally, data may be stored in the first memory 1202. The communication device 120 and the first memory 1202 may be arranged independently or may be integrated together.

Optionally, the communication device 120 may further include a transceiver 1205 and an antenna 1206. The transceiver 1205 may be referred to as a transceiving unit, a transceiving machine, a transceiving circuit, etc., and is used for implementing a transceiving function. The transceiver 1205 may include a receiver 1208 and a transmitter 1209. The receiver 1208 may be referred to as a receiving machine, a receiving circuit, etc., and is used for implementing a receiving function. The transmitter 1209 may be referred to as a transmitting machine, a transmitting circuit, etc., and is used for implementing a transmitting function.

Optionally, the communication device 120 may further include one or more interface circuits 1207. The interface circuit 1207 is used for receiving a code instruction and transmitting the code instruction to the first processor 1201. The code instruction is run by the first processor 1201, such that the method described in the above method embodiments is performed by the communication device 120.

In an implementation, the first processor 1201 may include a transceiver for implementing receiving and transmitting functions. For example, the transceiver may be a transceiving circuit, an interface, or an interface circuit. The transceiving circuit, the interface, and the interface circuit, which is used for implementing receiving and transmitting functions, may be independent or integrated. The above transceiving circuit, interface, and interface circuit may be used for reading and writing code/data, or the above transceiving circuit, interface, and interface circuit may be used for transmitting or transferring signals.

In an implementation, a first computer program 1203 may be stored in the first processor 1201. The first computer program 1203 is run on the first processor 1201, such that the method described in the above method embodiments is performed by the communication device 120. The first computer program 1203 may be embedded in the first processor 1201. In this case, the first processor 1201 may be implemented by hardware.

In an implementation, the communication device 120 may include a circuit. The transmitting, receiving, or communication function in the above method embodiments may be implemented by the circuit. The processor and transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may be fabricated through various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the above embodiment may be user equipment (such as the first user equipment and the second user equipment in the foregoing method embodiments) or a network device (such as the network device in the foregoing method embodiments), but the scope of the communication device described in the present disclosure is not limited to this. Moreover, the structure of the communication device may not be limited by FIG. 12. The communication device may be an independent device or a part of a large device. For example, the communication device may be as follows:
(1) an independent integrated circuit (IC), a chip, a chip system, or a subsystem;
(2) a set of one or more ICs, where optionally, the IC set may include a memory component for storing data and a computer program;
(3) an ASIC, such as a modem;
(4) a module that can be embedded in another device;
(5) a receiver, user equipment, an intelligent terminal device, a cellular phone, a wireless device, a handset, a mobile unit, a vehicle-mounted device, a network device, a cloud device, an artificial intelligence device, etc. ; or
(6) another device.

A case that the communication device may be a chip or a chip system can be obtained with reference to the schematic structural diagram of a chip shown in FIG. 13. The chip shown in FIG. 13 includes a second processor 1301 and an interface 1302. One or more second processors 1301 may be arranged, and a plurality of interfaces 1302 may be arranged.

In a case where the chip is used for implementing functions of first user equipment in an embodiment of the present disclosure, an interface 1302 is used for implementing S102 and S202 in FIG. 2, S103 in FIG. 3, S104 or S204 in FIG. 4, etc.

In a case where the chip is used for implementing functions of second user equipment in an embodiment of the present disclosure, an interface 1302 is used for implementing S106 in FIG. 6 or S107 in FIG. 7.

In a case where the chip is used for implementing functions of a network device in an embodiment of the present disclosure, an interface 1302 is used for implementing S109 in FIG. 9, or S1010 in FIG. 10, etc.

Optionally, the chip further includes a second memory 1303. The second memory 1303 is used for storing a necessary computer program and data.

Those skilled in the art will further know that various illustrative logical blocks and steps listed in embodiments of the present disclosure may be implemented by electronic hardware, computer software, or their combinations. Whether such functions are implemented by hardware or software depends on particular application and design requirements of the entire system. Those skilled in the art can implement functions through various methods for each type of specific application. However, such implementation should not be understood as falling beyond the protection scopes of embodiments of the present disclosure.

An embodiment of the present disclosure further provides a communication system. The system includes the communication device serving as the user equipment (such as the first user equipment and the second user equipment in the foregoing method embodiments) and the communication device serving as the network device (such as the network device in the foregoing method embodiments) in the embodiment of FIG. 11 mentioned above, or the system includes the communication device serving as the user equipment (such as the first user equipment and the second user equipment in the foregoing method embodiments) and the communication device serving as the network device (such as the network device in the foregoing method embodiments) in the embodiment of FIG. 12.

The present disclosure further provides a readable storage medium. Instructions are stored in the readable storage medium. The instructions, when executed by a computer, implement functions of any one of the above method embodiments.

The present disclosure further provides a computer program product. The computer program product is executed by a computer, such that functions of any one of the above method embodiments are implemented.

All or some of the above embodiments may be implemented by software, hardware, firmware, or their combinations. In a case where software is used for implementation, implementation may be entirely or partially carried out in a form of a computer program product. The computer program product includes one or more computer programs. The computer program instruction is loaded and executed on a computer, such that all or some of flows or functions according to embodiments of the present disclosure are generated. The computer may be a general-purpose computer, a dedicated computer, a computer network, or another programmable device. The computer program may be stored in a computer-readable storage medium or may be transmitted from a computer-readable storage medium to another computer-readable storage medium. For example, the computer instructions may be transmitted from a website, computer, server, or data center to another website, computer, server, or data center in a wired means (for example, a coaxial cable, an optical fiber, or a digital subscriber line (DSL)) or a wireless means (for example, infrared rays, radio, or microwave). The computer-readable storage medium may be any available medium that can be accessed by the computer, or a data storage device, such as a server or a data center in which one or more usable media are integrated. The available medium may be a magnetic medium (such as a floppy disk, a hard disk, and a magnetic tape), an optical medium (such as a digital video disc (DVD)), a semiconductor medium (such as a solid state disk (SSD)), etc.

Those of ordinary skill in the art can understand that various numerical numbers such as first and second involved in the present disclosure are merely used for ease of description, are not intended to limit the scopes of embodiments of the present disclosure, and further indicate sequence.

At least one in the present disclosure may alternatively be described as one or more, and a plurality of may be described as two, three, four, or more, which is not limited in the present disclosure. In embodiments of the present disclosure, technical features of a technical feature are distinguished by “first”, “second”, “third”, “A”, “B”, “C”, and “D”. The technical features described by “first”, “second”, “third”, “A”, “B”, “C”, and “D” are not in priority sequence or size sequence.

Corresponding relations shown in the tables in the present disclosure may be configured or predefined. Values of information in the tables are merely instances, and may be configured as other values, which is not limited in the present disclosure. When a corresponding relation between the information and each parameter is configured, not all corresponding relations indicated in the tables are required to be configured. For example, in the tables in the present disclosure, corresponding relations shown in some rows may not be configured. For another example, appropriate deformation adjustments can be made based on the above tables, such as splitting and merging. Other names that can be understood by the communication device may be used as names of parameters shown in titles of the above tables. Other values or expression modes that can be understood by the communication device may be used as values or expression modes of the parameters. When the above tables are implemented, other data structures may be used, such as an array, a queue, a container, a stack, a linear table, a pointer, a linked list, a tree, a graph, a structure, a class, a heap, a hash table, and a hash table.

Predefinition in the present disclosure may be understood as definition, predefinition, storage, prestorage, prenegotiation, preconfiguration, solidification, or prefiring.

Those of ordinary skill in the art can appreciate that units and algorithm steps described in combination with embodiments disclosed here can be implemented by electronic hardware, or a combination of computer software and electronic hardware. Whether these functions are executed by hardware or software depends on the specific application and design constraints of the technical solution. Those skilled in the art can implement the described functions through different methods for each particular application, but such implementation should not be considered as falling beyond the scope of the present disclosure.

Those skilled in the art can clearly understand that for convenience and conciseness of description, the specific working process of the systems, devices, and units described above can be obtained with reference to the corresponding process in the above methods embodiments, and will not be repeated here.

The above implementations are merely particular implementations of the present disclosure, but a protection scope of the present disclosure is not limited to this. Any change or substitution that may be easily conceived by those skilled in the art within the technical scope disclosed by the present disclosure should fall within the protection scope of the present disclosure. Thus, the protection scope of the present disclosure shall be subject to the protection scopes of the claims.

1. A method for inter-UE coordination (IUC) based on a sidelink, performed by a first user equipment, the method comprising:
receiving first information transmitted by a second user equipment, wherein the first information is configured to trigger an IUC function; and
transmitting second information to a network device in a case where the first user equipment is in a first resource allocation mode, wherein the second information is configured to request the network device to configure the first user equipment to be in a second resource allocation mode.

2. The method according to claim 1, wherein the first information comprises at least one of the following:
inter-UE coordination media access control control elements (IUC MAC CE) information;
inter-UE coordination request media access control control elements (IUC request MAC CE) information; or
proximity communication (PC) 5 interface-radio resource control (PC5-RRC) configuration information, wherein the PC5-RRC configuration information comprises a latency bound, and the latency bound is configured to control transmission time of the IUC MAC CE information.

3. The method according to claim 1, wherein transmitting the second information to the network device comprises at least one of the following:
transmitting a sidelink UE information (SUI) signaling to the network device, wherein the SUI signaling comprises the second information; or
transmitting a UE assistance information (UAI) signaling to the network device, wherein the UAI signaling comprises the second information.

4. The method according to claim 1, further comprising:
transmitting third information to the second user equipment;
receiving the third information transmitted by the second user equipment; or
receiving fourth information transmitted by the network device;
wherein the third information is configured to indicate support for the IUC function, and the fourth information is configured to configure the first user equipment to be in the second resource allocation mode.

5. The method according to claim 2, wherein the second information comprises at least one of the following:
second resource allocation mode request information; or
a latency bound, wherein the latency bound is configured to control transmission time of the IUC MAC CE information.

6. (canceled)

7. The method according to claim 1, further comprising:
transmitting fifth information to the second user equipment, wherein the fifth information is configured to indicate that the first user equipment is configured to be in the second resource allocation mode.

8. The method according to claim 7, wherein transmitting the fifth information to the second user equipment comprises:
transmitting a sidelink radio resource control (RRC) reconfiguration completion message to the second user equipment;
wherein the RRC reconfiguration completion message is used as the fifth information, and the first information is PC5-RRC configuration information, wherein the PC5-RRC configuration information comprises a latency bound, and the latency bound is configured to control transmission time of IUC MAC CE information.

9. The method according to claim 7, further comprising:
transmitting data to the second user equipment based on a preferred resource set, wherein the first information is IUC MAC CE information, and the IUC MAC CE information comprises the preferred resource set;
transmitting data to the second user equipment based on a resource, wherein the first information is IUC MAC CE information, the IUC MAC CE information comprises a non-preferred resource set, and the resource does not belong to the non-preferred resource set; or
transmitting IUC MAC CE information to the second user equipment, wherein the IUC MAC CE information comprises the preferred resource set or the non-preferred resource set, and the first information is IUC request MAC CE information.

10. The method according to claim 1, further comprising:
transmitting sixth information to the second user equipment, wherein the sixth information is configured to indicate at least one of: the first user equipment is not configured to be in the second resource allocation mode, or a cause of a situation that the first user equipment is not configured to be in the second resource allocation mode.

11. The method according to claim 10, wherein transmitting the sixth information to the second user equipment comprises:
determining elapsed time after the second information is transmitted to the network device, and transmitting the sixth information to the second user equipment in a case where the elapsed time reaches a time threshold and fourth information transmitted by the network device is not received, wherein the fourth information is configured to configure the first user equipment to be in the second resource allocation mode; or
transmitting a sidelink radio resource control (RRC) reconfiguration failure message to the second user equipment, wherein the RRC reconfiguration failure message is used as the sixth information, and the first information is PC5-RRC configuration information, wherein the PC5-RRC configuration information comprises a latency bound, and the latency bound is configured to control transmission time of IUC MAC CE information.

12. (canceled)

13. A method for inter-UE coordination (IUC) based on a sidelink, performed by a second user equipment, the method comprising:
transmitting first information to a first user equipment, wherein the first information is configured to trigger an IUC function.

14. (canceled)

15. The method according to claim 13, further comprising at least one of the following:
transmitting third information to the first user equipment; or
receiving the third information transmitted by the first user equipment;
wherein the third information is configured to indicate support for the IUC function.

16. The method according to claim 13, further comprising:
receiving fifth information transmitted by the first user equipment, wherein the fifth information is configured to indicate that the first user equipment is configured to be in a second resource allocation mode.

17. The method according to claim 16, wherein receiving the fifth information transmitted by the first user equipment comprises:
receiving a sidelink radio resource control (RRC) reconfiguration completion message transmitted by the first user equipment;
wherein the RRC reconfiguration completion message is used as the fifth information, and the first information is PC5-RRC configuration information, wherein the PC5-RRC configuration information comprises a latency bound, and the latency bound is configured to control transmission time of IUC MAC CE information.

18. The method according to claim 13, further comprising:
receiving data transmitted by the first user equipment, wherein the transmitted data is transmitted based on a preferred resource set, and the first information is IUC MAC CE information, wherein the IUC MAC CE information comprises the preferred resource set;
receiving data transmitted by the first user equipment, wherein the transmitted data is transmitted based on a resource, and the first information is IUC MAC CE information, wherein the IUC MAC CE information comprises a non-preferred resource set, and the resource does not belong to the non-preferred resource set;
receiving IUC MAC CE information transmitted by the first user equipment, wherein the IUC MAC CE information comprises the preferred resource set or the non-preferred resource set, and the first information is IUC request MAC CE information; or
receiving sixth information transmitted by the first user equipment, wherein the sixth information is configured to indicate at least one of: the first user equipment is not configured to be in a second resource allocation mode, or a cause of a situation that the first user equipment is not configured to be in the second resource allocation mode.

19-20. (canceled)

21. A method for inter-UE coordination based on a sidelink, performed by a network device, the method comprising:
receiving second information transmitted by a first user equipment, wherein the second information is configured to request the first user equipment to be configured to be in a second resource allocation mode.

22. The method according to claim 21, wherein receiving the second information transmitted by the first user equipment comprises at least one of:
receiving a sidelink UE information (SUI) signaling transmitted by the first user equipment, wherein the SUI signaling comprises the second information; or
receiving a UE assistance information (UAI) signaling transmitted by the first user equipment, wherein the UAI signaling comprises the second information.

23. (canceled)

24. The method according to claim 21, further comprising:
transmitting fourth information to the first user equipment, wherein the fourth information is configured to configure the first user equipment to be in the second resource allocation mode.

25-27. (canceled)

28. A communication device, comprising:
a processor; and
a memory that stores a computer program, wherein
the processor, when executing the computer program stored in the memory, causes the communication device to perform the method according to claim 1.

29-30. (canceled)

31. A non-transitory computer-readable storage medium storing instructions, wherein the instructions, when executed, implement the method according to claim 1.

32-34. (canceled)
